(19) United States
(12) Patent Application Publication
(10) Pub. No.: US 2007/0283821 A1
(43) Pub. Date: Dec. 13, 2007

(54) Waffle maker and method of making filled waffles using the same

(75) Inventors: Richard L. May, Manhattan Beach, CA (US); Debby Young, Southport, CT (US)

Correspondence Address: YING CHEN;Chen Yoshimura LLP, 255 S. GRAND AVE., # 215, LOS ANGELES, CA, 90012, US

(73) Assignee: The Helman Group, Ltd.

(21) Appl. No.: 11/450,095

(22) Filed: Jun. 9, 2006

(51) Int. Cl. A47J 37/06

(52) U.S. Cl. 99/372

(57) ABSTRACT

A waffle maker set for making filled waffles includes a waffler, a tunnel forming device and a filling injector. The waffler has heated top and bottom grills each having a plurality of protruding blocks on its inside. The tunnel forming device has blades with a shape corresponding to the arrangement of the blocks in the grills. With the waffler open, a waffle mix is added on the grills and allowed to pre-bake. The tunnel forming device is pressed into the mix in the space between the blocks to form grooves in the mix. When the waffler is closed, the grooves form tunnels inside the mix. A nose of the filling injector is inserted through one or more holes on the top grill of the waffler to reach into the tunnels, and a filling material (e.g. jelly) is injected into the tunnels to form filled waffles.

### BACKGROUND OF THE INVENTION

1. Field of the Invention

This invention relates to a device for making food items filled with a viscous edible material and a method of using such a device.

2. Description of the Related Art

Waffle makers and other baking devices having two heated platens are well known in the art. It is customary, after baking, to prepare the baked food item (waffle, donut, or the like) for eating by covering the food item with syrup, jam, frosting, custard, pudding, scrambled eggs, etc. This creates a flavorful and tasty food. However, the result is messy and must be eaten from a plate with a spoon or a fork.

### SUMMARY OF THE INVENTION

The present invention provides a waffle maker suitable for making waffles filled with a viscous edible material and a method of making such waffles.

An object of the present invention is to provide a device and method for creating a food treat that is less messy and can be eaten while being held in the hands by placing the frosting, jam, etc. inside the food item.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a waffle making set which includes: a waffler including a top grill and a bottom grill each having a rim and a plurality of protruding blocks on the inside, wherein one or more holes are defined in the top grill and open into a space between the blocks inside the top grill; a tunnel forming device including a plurality of blades, the blades being arranged to correspond to spaces defined between the plurality of blocks inside the top or bottom grill; and one or more filling injectors each including a tube for containing a filling material and a pointed nose at a bottom end of the tube, wherein a size of the nose is smaller than a size of the holes on the top grill of the waffler.

In another aspect, the present invention provides a method for making filled waffles using the waffle making set, which includes: (a) heating the top and bottom grills; (b) opening the waffler and adding a waffle mix into the top and bottom grills; (c) allowing the waffle mix to bake in the top and bottom grills until it attains sufficient rigidity; (d) forming a plurality of grooves in the waffle mix by pressing the blades of the tunnel forming device into the waffle mix; (e) closing the waffler, whereby the grooves form tunnels inside the waffle mix; and (f) inserting the nose of the filling injector which has been filled with a filling material through the holes in the top shell and top grill and injecting the filling material into the tunnels inside the waffle mix.

Defined broadly, the present invention provides a device for making filled food items, which includes: a cooking device including a top heated platen and a bottom heated platen, wherein one or more holes are defined in the top heated platen and open into a space inside the top heated platen; a tunnel forming device including one or more protrusions arranged to correspond to an interior shape of the top or bottom heated platen; and one or more filling injectors each including a tube for containing a filling material and a pointed nose at a bottom end of the tube, wherein a size of the nose is smaller than a size of the holes on the top heated platen.

It is to be understood that both the foregoing general description and the following detailed description are exemplary and explanatory and are intended to provide further explanation of the invention as claimed.

### BRIEF DESCRIPTION OF THE DRAWINGS

FIGS. 1(a), 1(b) and 1(c) show a waffler, a tunnel forming device and a filling injector of a waffle maker set according to an embodiment of the present invention.

FIG. 2(a) shows the waffler in an open state.

FIG. 2(b) is a partial schematic top view of the top grill of the waffler.

FIG. 3(a) illustrates a process of forming tunnels in a waffle mix.

FIG. 3(b) is a cross-sectional view illustrating the grooves formed in the waffle mix.

FIG. 4 illustrates a filling injector inserted into a hole of the waffler.

### DETAILED DESCRIPTION OF THE PREFERRED EMBODIMENTS

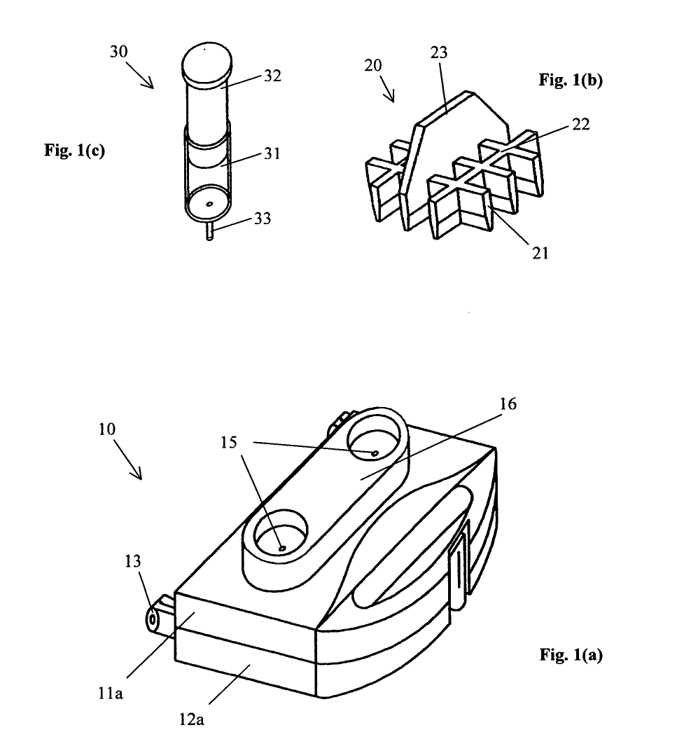

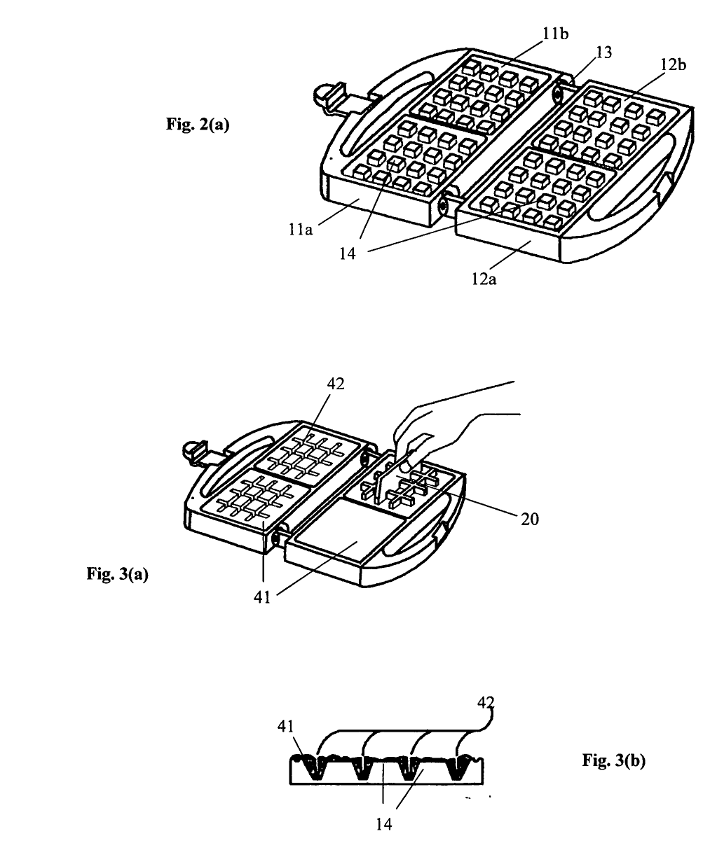

As shown in FIGS. 1(a)-(c), the waffle maker set according to an embodiment of the present invention includes a waffler 10, a tunnel forming device 20 and one or more filling injectors 30 (only one is shown). FIG. 2(a) shows the waffler 10 in an open state. FIG. 2(b) is a partial schematic top view of the top grill of the waffler (a half of the top grill of FIG. 2(a) is shown). As shown in FIGS. 1(a) and 2(a)-(b), the waffler 10 includes a top shell 11a and a bottom shell 12a joined by a pair of hinges 13. Mounted inside the top and bottom shells 11a and 12a are top and bottom grills 11b and 12b, respectively, each of which is shaped as a tray with a rim and a plurality of protruding blocks 14 on the bottom. In the embodiment shown in FIGS. 2(a)-(b), the blocks 14 are rectangular in shape with a trapezoidal cross section and are arranged in a regular array, but other shapes and arrangements of the blocks can also be used. The heights of the blocks are lower than the height of the rim of the top and bottom grills, and the blocks in the top grill are located above the corresponding blocks in the bottom grill when the waffler 10 is closed. The top and bottom shells 11a and 12a may be made of any suitable materials, such as plastic or metal, while the top and bottom grills 11b and 12b are made of a material suitable for a cooking surface, such as metal. The top and bottom grills 11b and 12b are heated by electrical heating elements disposed inside the shells (not shown). The waffler also has a cable (not shown) for plugging into an electrical outlet, and optionally, switches and/or working condition indicators (not shown).

The tunnel forming device 20 has a plurality of intersecting blades 21 forming a grid 22 mounted on a handle 23. The grid 22 has a size and shape such that when it is placed over the top or bottom grill, the hollow parts of the grid correspond to the blocks 14 and the blades 21 correspond to the space between the blocks. The tunnel forming device 20 is made of plastic or other suitable materials. The tunnel forming device may have other shapes than that illustrated in FIG. 1(b), depending on the shape of the grills. The filling injector 30 is an applicator with a hollow tube 31 for containing a filling material, a plunger 32 fitted inside the tube, and a pointed nose 33 at the bottom end of the tube. The filling injector 30 is made of a plastic or other suitable material. Alternatively, instead of a using plunger 32, the filling injector may be a re-sealable squeeze tube having an opening for loading a filling material, where the opening can be re-sealed so that the filling may be injected from the nose by squeezing the tube.

One or more through holes 15 are provided in the top shell 11a and top grill 11b to form a tunnel connecting the inside of the top grill 11b to the exterior of the waffler 10. Two holes 15 are shown in the embodiment of FIG. 1(a) as seen from the exterior. As schematically shown in FIG. 2(b), the hole 15 is located between the blocks 14 on the inside of the top grill 11b. The size of the holes 15 is sufficiently large to allow the nose 33 of the filling injector 30 to be inserted into the hole and reach the inside of the waffler. Optionally, the top shell 11 a may have one or more support structures 16 on the outside around the holes to support the filling injector 30 when it is inserted into the holes. Preferably, the interior sidewall of the through hole 15 is a continuous piece of material, which may be an extension of the top grill 11b (i.e. an upwardly extending tube formed integrally with the top grill 11b and fitted in the hole of the top shell 11a), an extension of the top shell 11a (i.e. a downwardly extending tube formed integrally with the top shell 11a and fitted in the hole of the top grill 11b), or a separate piece (i.e. a tube fitted into the holes in the top shell 11a and top grill 11b). This provides the advantage of preventing the filling material that may leak from the filling injector from entering into a crack that may exist between the top shell 11a and the top grill 11b when the filling injector 30 is inserted into and withdrawn from the hole.

The process of making a filled waffle using the waffler 10, the tunnel forming device 20 and the filling injector 30 is described now.

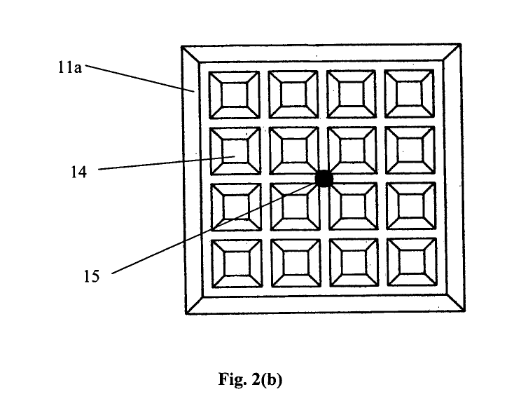

First, close the waffler and apply electricity to heat the top and bottom grills 11b and 12b. Then open the waffler and add a waffle mix to the inside of the top and bottom grills until the mix just covers the tops of the blocks 14. Preferably, the inside surface of the grills is coated with butter, margarine, vegetable oil, a non-stick spray or other suitable materials before the waffle mix is added. The mix is allowed to bake in the grill slightly. The purpose of this pre-baking step is to ensure that when the tunnel forming device is used (described below), the mix is sufficiently rigid so the mix will actually form grooves instead of running and collapsing the grooves. The time duration of this pre-baking step may be difficult to determine beforehand as it depends on various factors such as the temperature of the grill, the nature of the waffle mix, etc., but a user can readily observe the mix to determine whether it is sufficiently baked. If the tunneling device is used before the mix has sufficient rigidity, the user needs only wait a few seconds a try again. Then, use the tunnel forming device 20 to form grooves 42 in the waffle mix 41 by pressing the blades 21 into the mix at locations corresponding to the spaces between the blocks 14, as shown in FIG. 3(a). Preferably, the blades 21 of the tunnel forming device 20 are dipped in butter or some other oil before pressing to prevent the waffle mix from sticking to the blades. The blades 21 of the tunnel forming device 20 have appropriate thicknesses to give the grooves 42 a desired width. FIG. 3(b) illustrates a cross-sectional view of the grooves 42 formed in the waffle mix.

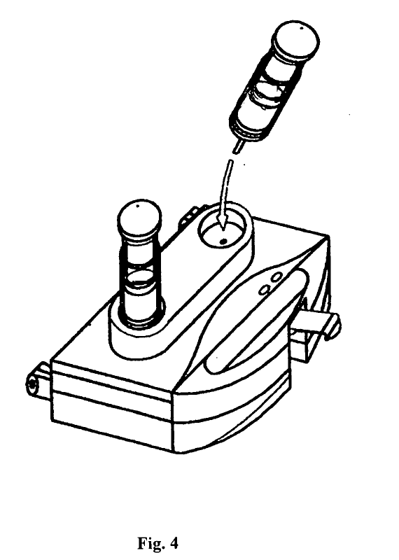

When the waffler is then closed, the waffle mix in the top and bottom grills 11b and 12b are joined together and the grooves 42 in the two grills form interconnected tunnels inside the mix for the filling material. Bake the waffle mix for an appropriate length of time (e.g. a few minutes) with the waffler closed, then use the filling injector 30 to form holes in the waffle mix by pressing the nose 33 into the holes 15 on the top grill (see FIG. 4, but preferable with the injector empty). The length of the nose 33 of the filling injector 30 is such that it will pass through the waffle mix and reach the tunnels formed inside the mix. Bake the waffle mix for an additional length of time (e.g. a few minutes), then disconnect the electricity and allow the waffle to cool for a length of time (e.g. a few minutes). Fill the filling injector 30 with a desired filling material, such as jelly, syrup, jam, frosting, custard, pudding, etc. This is done by removing the plunger 32, filling the tube 31 with the filling, re-placing the plunger, and removing air from the tube by turning it upside down and push the plunger until air is pushed out. A squeeze tube can be similarly filled. After the appropriate cooling time, insert the nose 33 of the injector 30 into the holes 15 on the waffler, and inject the filling into the tunnels in the waffle by slowly pushing the plunger 32 down (see FIG. 4) or squeeze the tube. The filled waffles are now finished and can be removed from the waffler.

From the above descriptions, it can be seen that a baking or cooking device (e.g. a waffle maker) according to embodiments of the present invention can be used to create passages internal to a closed cooked or baked item. Additionally, it can be used to inject a secondary substance into the passages while the cooked or baked item is still in the baking or cooking device.

It will be apparent to those skilled in the art that various modification and variations can be made in the waffle maker filled-waffle making method of the present invention without departing from the spirit or scope of the invention. For example, the tunnel forming device 20 and the blocks 14 inside the grills 11b and 12b may have different shapes than those shown in FIGS. 1(b), 2(a) and 2(b), so long as their shapes correspond to each other so that tunnels can be formed in the waffle mix. The shape of the inside tray of the top and bottom grills can be different than those shown in FIGS. 2(a) and 2(b), and their bottom surfaces can be concave so the top/bottom shape of the waffle product can vary. In addition, although a waffle maker is described and illustrated in detail, the invention can be applied to other devices with heated two-part (top and bottom) cavity for making other food items, such as donuts, etc. Thus, it is intended that the present invention cover modifications and variations that come within the scope of the appended claims and their equivalents.

What is claimed is:

1. A waffle making set comprising:
a waffler including a top grill and a bottom grill each having a rim and a plurality of protruding blocks on the inside, wherein one or more holes are defined in the top grill and open into a space between the blocks inside the top grill;
a tunnel forming device including a plurality of blades, the blades being arranged to correspond to spaces defined between the plurality of blocks inside the top or bottom grill; and
one or more filling injectors each including a tube for containing a filling material and a pointed nose at a bottom end of the tube, wherein a size of the nose is smaller than a size of the holes on the top grill of the waffler.

2. The waffle making set of claim 1, further including a top shell and a bottom shell pivotally joined together, wherein the top and bottom grills are mounted inside the top and bottom shells, respectively, and wherein one or more holes are defined in the top shell corresponding in locations to the holes in the top grill.

3. The waffle making set of claim 2, where the one or more holes in the top grill and the top shell form one or more holes each having a continuous sidewall.

4. The waffle making set of claim 2, wherein the blocks in the top and bottom grills have heights lower than heights of the rims of the top and bottom grills, respectively, and wherein the blocks in the top grill are located above corresponding blocks in the bottom grill when the top and bottom grills are closed.

5. The waffle making set of claim 1, wherein the blocks are rectangular in shape with a trapezoidal cross section and are arranged in a regular array in the top and bottom grills.

6. The waffle making set of claim 1, wherein the top and bottom gills are heated grills.

7. The waffle making set of claim 1, wherein the top and bottom grills are made of metal.

8. The waffle making set of claim 1, wherein the tunnel forming device further includes a handle connected to the blades.

9. The waffle making set of claim 1, wherein the tunnel forming device is made of a plastic material.

10. The waffle making set of claim 1, wherein each filling injector further includes a plunger fitted inside the tube for injecting the filling material contained therein through the nose.

11. A method for making filled waffles using the waffle making set of claim 2, comprising:
(a) heating the top and bottom grills;
(b) opening the waffler and adding a waffle mix into the top and bottom grills;
(c) allowing the waffle mix to bake in the top and bottom grills until it attains sufficient rigidity;
(d) forming a plurality of grooves in the waffle mix by pressing the blades of the tunnel forming device into the waffle mix;
(e) closing the waffler, whereby the grooves form tunnels inside the waffle mix; and
(f) inserting the nose of the filling injector which has been filled with a filling material through the holes in the top shell and top grill and injecting the filling material into the tunnels inside the waffle mix.

12. The method of claim 11, wherein step (b) further comprises coating the top and bottom grills before adding the waffle mix.

13. The method of claim 11, wherein step (d) further comprises dipping the blades of the tunnel forming device in an oil before pressing them into the waffle mix.

14. The method of claim 11, further comprising, after step (e) and before step (f):
allowing the waffle mix to bake;
inserting the nose of one of the filling injectors through the holes in the top shell and top grill to form a hole in the waffle mix that connects the tunnels inside the waffle mix with the exterior of the waffler; and
allowing the waffle mix to cool down in the closed grills.

15. A device for making filled food items, comprising:
a cooking device including a top heated platen and a bottom heated platen, wherein one or more holes are defined in the top heated platen and open into a space inside the top heated platen;
a tunnel forming device including one or more protrusions arranged to correspond to an interior shape of the top or bottom heated platen; and
one or more filling injectors each including a tube for containing a filling material and a pointed nose at a bottom end of the tube, wherein a size of the nose is smaller than a size of the holes on the top heated platen.
